(19) United States
(12) Patent Application Publication
(10) Pub. No.: US 2015/0108777 A1
(43) Pub. Date: Apr. 23, 2015

(54) Camera pole

(71) Applicants: Anthony Francis Anari, III, Vernon, NJ (US); Ryan Paul Vosburg, Riverdale, NJ (US); Russell VanZile, III, Riverdale, NJ (US)

(72) Inventors: Anthony Francis Anari, III, Vernon, NJ (US); Ryan Paul Vosburg, Riverdale, NJ (US); Russell VanZile, III, Riverdale, NJ (US)

(21) Appl. No.: 13/998,324

(22) Filed: Oct. 21, 2013

(51) Int. Cl. G03B 17/56

(52) U.S. Cl. CPC G03B 17/563; G03B 17/566
USPC 294/139

(57) ABSTRACT

A camera-mounting pole device including an air tight plastic tube with a first end and second end, a plastic end cap secured to the second end of the tube, a rubber hand grip secured to the first end of the tube, and a mounting piece having a plurality of prongs extending outwardly therefrom secured to the plastic end cap. The prongs are configured for receipt of an image capturing device or case therefore to releasably secure to the same. Each prong has a hole configured for receipt of a screw. The prongs are spaced apart and adapted to intermittently align with corresponding prongs of an image capturing device. The pole is preferably clear plastic that can uphold an image capturing device thereby enabling a photographer to capture images of himself or surroundings without a noticeable camera pole being present in the image.

### CROSS-REFERENCE TO RELATED APPLICATIONS

This application claims the benefit of U.S. Provisional Application #61/716,555, filed Oct. 21, 2012.

### DEFINITIONS

Image Capturing Device—when the terms “image capturing device” are used together in this application they mean any instrument that can capture an image such as a smartphone, a camera or a video camera.

Encased—when the term “encased” is used in this application it means a casing that surrounds a camera, smartphone or a video camera.

### FIELD OF THE INVENTION

This invention relates to cameras, and moreover, camera supports. Specifically, the present invention comprises a clear, handheld pole that can uphold an image capturing device such as a camera or a video camera.

### DESCRIPTION OF THE PRIOR ART

Many people taking pictures or videos use a variety of supports to uphold their image capturing devices. However, these items are usually dark in color, bulky, and do not move easily. This presents two problems: the support is visible in pictures and the support is difficult to manage resulting in limited use of the support. This camera pole of the present invention seeks to solve both problems. This invention is a clear, handheld pole that can uphold an image capturing, device such as a camera or a video camera. This camera pole is clear, making it nearly invisible in images. Additionally this invention is thin and lightweight making it easy to use in the field of photography. This invention is also airtight making it buoyant in water.

This invention solves the problem of supports being visible in images, especially when the photographer is the subject of the photo itself. The currents trends in photography include capturing images of people, wild life and landscapes with the photographer being included in the image. Thus there is a need for a support that will move easily with the photographer, that can be held by the photographer and that will remain nearly invisible in any images that have been captured. This invention solves this problem because it is clear, thin and lightweight which makes it nearly invisible and easily maneuverable for a user to hold and position for capturing a photograph.

This invention also solves the problem of image capturing device supports being difficult to manage. This invention is easy to manage because it is thin and lightweight unlike other supports, which are heavy and bulky. The ease of use of this invention is a distinct feature which is advantageous over prior art traditional camera supports and tripods.

### SUMMARY OF THE INVENTION

This invention is a preferably clear, handheld device that can uphold an image capturing device thereby enabling a photographer to capture images aimed in his own direction and possibly including himself without a noticeable camera pole being present in the image. The purpose of the device is to enable a photographer to film and or photograph himself without the noticeable image of a grip or pole in the photo. This device's clear design allows it to go practically unnoticed in most images. The design is also hollow and airtight which allows the pole to float an image capturing device in water.

The present invention preferably comprises a hollow rubber grip which can be slid over and secured to a plastic tube. A mounting piece can be secured to the opposite end of the pole as the rubber grip, the mounting piece preferably made of polypropylene and preferably comprising three prongs on the end thereof extending outwardly from the mounting piece. Each prong preferably comprises a ¾ inch hole that allows for a screw to pass through and on the outermost portion of one of the ¾ inch holes and further comprises a circular extension secured to a ½inch by ½ inch metal cap. To use the camera pole of the present invention, the image capturing device can be fitted into the mounting piece on the top of the camera pole and a thumbscrew can be screwed through both the image capturing device or it's case and the prongs of the mounting piece to secure the image capturing device or its case to the camera pole of the present invention. The image capturing device or its case must have the corresponding three prongs that match up with the mounting device in order to be fastened properly.

In an alternative embodiment, on the second end of the plastic tube, a mounting piece having a screw is attached. The screw is preferably ¼″ by 20 thread per inch screw that is 5 mm high and 6 mm wide. The camera pole is used by attaching it to an image capturing device or it's case by screwing the screw on the camera pole directly into the image capturing device or it's case.

The present invention is lightweight and clear allowing for an almost unnoticeable appearance in any image. The clear construction of makes the pole itself nearly undetectable in almost all images. This transparency of the pole, in turn, allows the photographer to capture images of himself which, prior to this invention, were difficult to obtain without the pole or support holding the image capturing device being seen, at least partially, in the photo. The weight of this camera pole enables the photographer to hold the pole and steady the image capturing device for extended periods of time. The design of the device is also such that it is hollow and airtight allowing the pole to float itself and thus float an image capturing device in water.

### BRIEF DESCRIPTION OF THE DRAWINGS

FIG. 1 is a front perspective view of the present invention, a camera pole, secured to an image capturing device;

FIG. 2 is a close-up front perspective view of the mounting piece end of the camera pole seen in FIG. 1 when not secured to an image capturing device;

FIG. 3 is a close-up front perspective view of the rubber grip end of the camera pole seen in FIG. 1; and

FIG. 4 is a close-up front perspective view of the mounting piece end of the camera pole seen in FIG. 2 having been secured to an image capturing device.

### DETAILED DESCRIPTION OF THE INVENTION

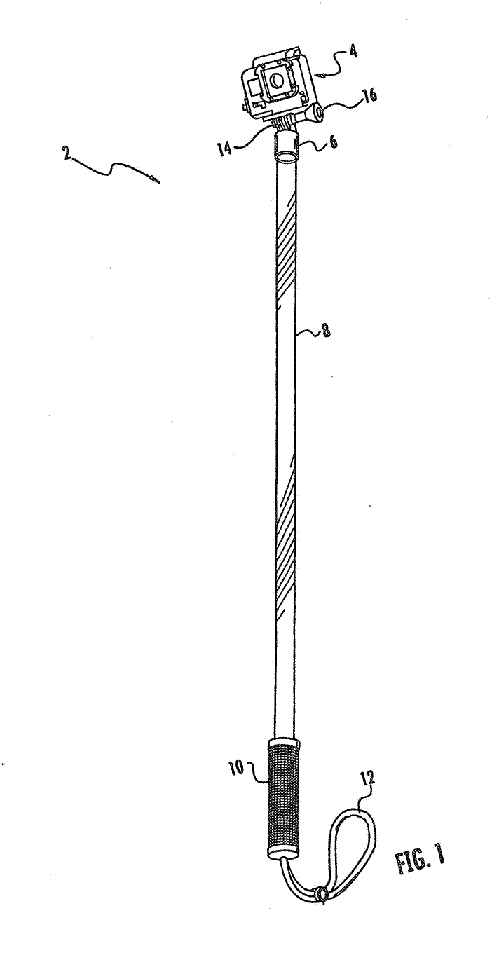

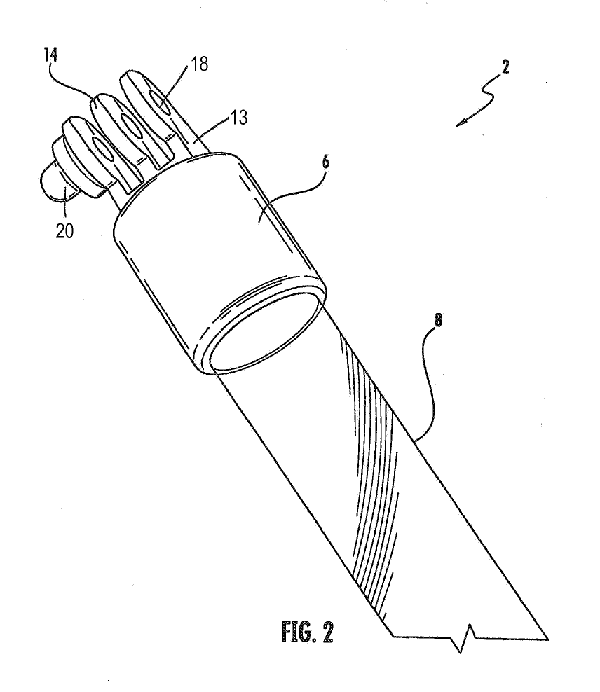

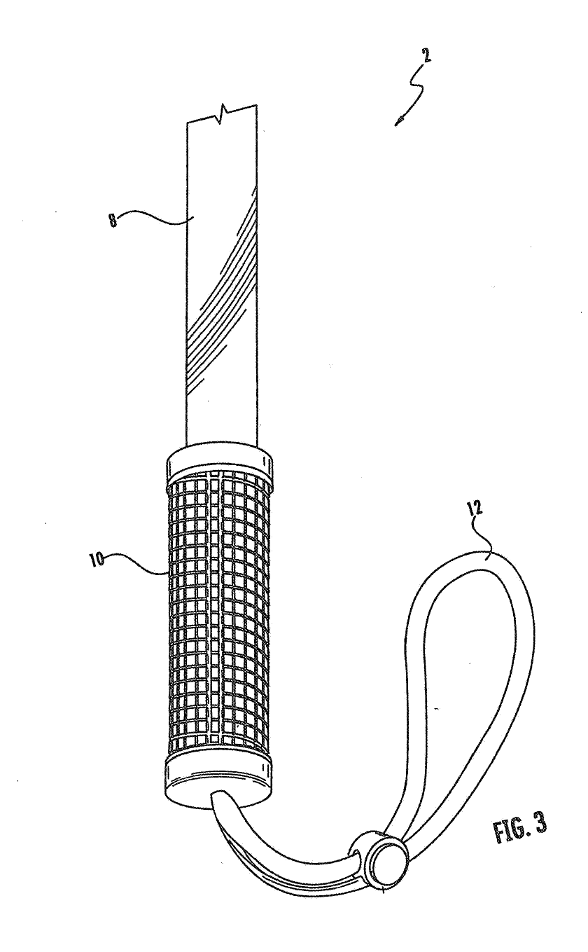

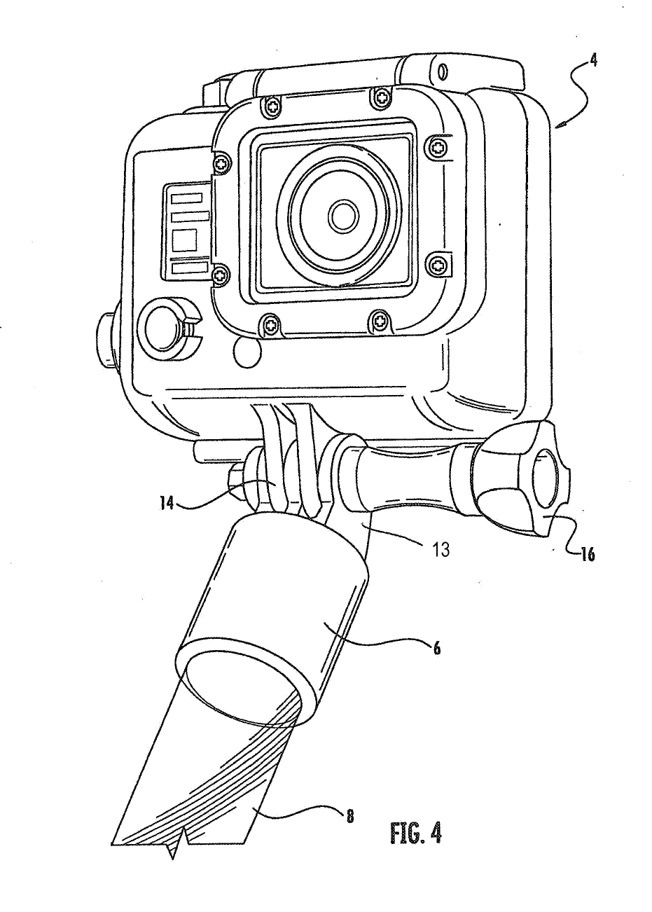

Description will now be given of the invention with reference to the attached FIGS. 1-4. It should be understood that these figures are exemplary in nature and in no way serve to limit the scope of the invention as the invention will be defined by claims, and the scope of the invention will be the scope of the claims, as interpreted by the Courts.

The present invention is a clear, handheld camera pole device 2 that can uphold an image capturing device 4 thereby enabling a photographer to capture images of himself or his surroundings in his direction without a noticeable camera pole being present in the image. This device's clear design allows it to go practically unnoticed in most images. The design is also hollow and airtight which allows the pole to float an image capturing device in water.

The camera pole of the present invention includes a clear pole device that is preferably comprised of an airtight plastic tube 8 that is sealed air tight on both ends. There is also preferably a rubber hand grip 10 that is attached to the first end which allows the user to utilize a firm grip on the device. The rubber hand grip 10 is preferably 4½ inches long, and the plastic tube 8 is preferably 26 inches long. There is additionally preferably a strap 12 that is attached to the grip 10 and is configured to slide around the arm of a user holding the rubber grip of the camera pole. On the second end of the pole 8 opposite the rubber grip 10, there is preferably a 1 inch long by 1 inch wide plastic end cap 6 that is fastened to the end of the tube.

The rubber grip 10 on the camera pole 8 is preferably hollow, and is more preferably 1¼ inches wide and 4½ inches long, and it has one open end and one closed end. The grip can be then slid onto the plastic tube 8 and secured thereto. Next, a preferably three pronged mounting piece 13 is secured to the opposite end of the plastic pole as that secured to the rubber grip 10. The mounting piece 13 is comprised of three prongs 14 and is attached to the plastic end cap on the plastic tube. Each prong preferably contains a ¾ inch hole 18 that allows for a screw 16 to pass through. On the outermost portion of one of the ¾ inch holes there is a circular extension 20 that a ½ inch by ½ inch metal cap is secured to.

To use the camera pole, the image capturing device 4 or its case must first be fitted into the mounting piece 13 on the camera pole and secured thereto using a thumbscrew 16. The thumbscrew must pass through both the prongs on the image capturing device or it's case and the corresponding prongs 14 on the mounting piece 13, thus securing the image capturing device to the camera pole. The image capturing device or its case must have the corresponding three prongs that match up with the mounting device in order to be screwed in properly.

In an alternative embodiment, on the second end of the plastic pole, a mounting piece comprising a screw and a plastic end cap is secured to the plastic pole 8. The camera pole is then attached to an image capturing device or its case by screwing the screw into the case or into the image capturing device itself.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A camera-mounting pole device comprising:
a plastic tube with a first end and a second end that is that is sealed air tight;
a plastic end cap that is fastened to the second end of the tube;
a rubber hand grip that is attached to the first end;
a mounting piece, comprising a plurality of prongs extending outwardly therefrom, secured to the plastic end cap, the plurality of prongs configured for receipt of an image capturing device or case therefore to releasably secure to the same.

2. The camera-mounting pole device of claim 1, wherein the plastic tube is made of clear plastic.

3. The camera-mounting pole device of claim 1, wherein the plastic tube is made of colored plastic.

4-6. (canceled)

7. The camera-mounting pole device of claim 1, wherein said plastic tube is about 26 inches long.

8. The camera-mounting pole device of claim 1, wherein the hand grip is about 4½ inches long.

9. The camera-mounting pole device of claim 1, further comprising a strap secured to the rubber hand grip, configured to loop around the wrist of a user.

10. The camera-mounting pole device of claim 1, wherein the plurality of prongs comprises three prongs.

11. The camera-mounting pole device of claim 1, wherein each prong comprises a hole configured for receipt of a screw.

12. The camera-mounting pole device of claim 11, wherein the hole is ¾ inches in diameter.

13. A camera-mounting pole device comprising:
a plastic tube with a first end and a second end that is that is sealed air tight;
a rubber hand grip secured to the first end of the plastic tube;
a mounting piece, secured to the second end of the plastic tube, the mounting piece comprising a screw configured to secure to an image capturing device or case therefore.

14. The camera-mounting pole device of claim 13, wherein the plastic tube is made of clear plastic.

15. The camera-mounting pole device of claim 13, wherein the plastic tube is made of colored plastic.

16. The camera-mounting pole device of claim 13, wherein the mounting piece comprises a plurality of prongs, said prongs configured to secure to corresponding prongs on an image capturing device or case therefore.

17. The camera-mounting pole device of claim 16, wherein the plurality of prongs is three.

18. The camera-mounting pole device of claim 13, wherein said plastic tube is about 26 inches long.

19. The camera-mounting pole device of claim 13, wherein the hand grip is about 4½ inches long.

20. The camera-mounting pole device of claim 13, further comprising a strap secured to the rubber hand grip, configured to loop around the wrist of a user.

21. The camera-mounting pole device of claim 16, wherein each prong comprises a hole configured for receipt of a screw.

22. The camera-mounting pole device of claim 21, wherein the hole is ¾ inches in diameter.

23. The camera-mounting pole device of claim 13, wherein the screw is 5 mm high and 6 mm wide.
